(19) United States
(12) Patent Application Publication
(10) Pub. No.: US 2006/0062894 A1
(43) Pub. Date: Mar. 23, 2006

(54) 7S/2S-rich soy protein globulin fraction composition and process for making same

(76) Inventors: Houston S. Smith, St. Louis, MO (US); Theodore C. Busch, St. Louis, MO (US)

Correspondence Address: SOLAE, LLC, PO BOX 88940, ST LOUIS, MO, 63188, US

(21) Appl. No.: 11/233,970

(22) Filed: Sep. 23, 2005

Related U.S. Application Data
(60) Provisional application No. 60/612,364, filed on Sep. 23, 2004.

(51) Int. Cl. A23J 1/00

(52) U.S. Cl. 426/656

(57) ABSTRACT

Disclosed is a soy protein composition, comprising; a mixture of 7S and 2S rich protein fraction having a β-conglycinin content greater than about 45% by weight on a moisture free basis, and having an a content of from about 15% up to about 30% by weight on a moisture free basis, an α′ content of from about 22% up to about 40% by weight on a moisture free basis and a β content of from about 5% up to about 18% by weight on a moisture flee basis: a glycinin content of from about 13% up to about 45% by weight on a moisture free basis; wherein a weight ratio of β-conglycinin to glycinin in the soy protein composition is from about 1 up to about 6; and wherein a TIU/mg content in the soy protein composition is from about 50 up to about 125 before denaturation and from about 5 up to about 30 after denaturation. Also disclosed is a process for preparing a mixture of 7S and 2S rich protein fraction having a β-conglycinin content greater than about 45% by weight on a moisture free basis, and having an a content of from about 15% up to about 30% by weight on a moisture free basis, an α′ content of from about 22% up to about 40% by weight on a moisture free basis and a β content of from about 5% up to about 18% by weight on a moisture free basis; a glycinin content of from about 13% up to about 45% by weight on a moisture free basis; wherein a weight ratio of β-conglycinin to glycinin in the soy protein composition is from about 1 up to about 6; and wherein a TIU/mg content in the soy protein composition is from about 50 up to about 125 before denaturation and from about 5 up to about 30 after denaturation, the process comprising: in a first precipitation, precipitating a soybean 11S-rich globulin fraction from a dispersion of soy protein in a liquid medium, thereby forming a first supernatant liquid medium, separating said soybean 11S-rich globulin fraction from said first supernatant liquid medium, in a second precipitation, precipitating a mixture of a soybean 11S-rich globulin fraction and a soybean 7S-rich globulin fraction from said first supernatant liquid medium, thereby forming a second supernatant liquid medium, and in a third precipitation, precipitating a mixture of 7S-rich globulin fraction and 2S-rich fraction from said second supernatant liquid.

### CROSS REFERENCE TO RELATED APPLICATIONS

This application claims the benefit under Title 35, USC. § 119(e) of U.S. Provisional Patent Application Ser. No. 60/612,364 titled Fractionation and Isolation of Soybean Protein Globulins, filed on Sep. 23, 2004.

### FIELD OF THE DISCLOSURE

This disclosure relates to a soy protein composition of a mixture of 7S and 2S rich protein fraction, and to processes for preparing the soy protein composition of the mixture of 7S and 2S rich protein fraction, suitable for use as functional food ingredients, and food products that contain the soy bean 7S/2S-rich globulin fraction.

### BACKGROUND OF THE DISCLOSURE

Plant protein materials are used as functional food ingredients, and have numerous applications in enhancing desirable characteristics in food products. Soy protein materials, in particular, have seen extensive use as functional food ingredients. Soy protein materials are used as an emulsifier in meats, including frankfurters, sausages, bologna, ground and minced meats, and meat patties, to bind the meat and give the meat a good texture and a firm bite. Another common application for soy protein materials as functional food ingredients is in creamed soups, gravies, and yogurts where the soy protein material acts as a thickening agent and provides a creamy viscosity to the food product. Soy protein materials are also used as functional food ingredients in numerous other food products such as dips, dairy products (for example, soy milk), tuna, breads, cakes, macaroni, confections, whipped toppings, baked goods, beverages (e.g., fruit juice), and many other applications.

Soy protein materials are generally in the form of soy flakes, soy protein concentrates, or soy protein isolates. Soy flakes are generally produced by dehulling, defatting, and grinding the soybean and typically contain less than 65 wt. % soy protein on a moisture-free basis (more generally from 45 wt. % to 65 wt. % soy protein on a moisture-free basis). Soy flakes also contain soluble carbohydrates, insoluble carbohydrates such as soy fiber, and fat inherent in soy. Soy flakes may be defatted, for example, by extraction with hexane. Soy flours, soy grits, and soy meals are produced from defatted soy flakes by comminuting the flakes in grinding and milling equipment such as a hammer mill or an air jet mill to a desired particle size. The comminuted materials are typically heat treated with dry heat or steamed with moist heat to “toast” the ground flakes and inactivate anti-nutritional elements present in soy such as Kunitz trypsin inhibitors. Heat treating the ground, defatted flakes in the presence of significant amounts of water is avoided to prevent denaturation of the soy protein in the material and to avoid costs involved in the addition and removal of water from the soy material. The resulting ground, heat treated material is a soy flour, soy grit, or a soy meal, depending on the average particle size of the material. Soy flour generally has a particle size of less than 150 μm. Soy grits generally have a particle size of 150 to 1000 μm. Soy meal generally has a particle size of greater than 1000 μm.

Soy protein concentrates typically contain 65 wt. % to 85 wt. % soy protein, with the major non-protein component being fiber. Soy protein concentrates may be formed from defatted soy flakes by washing the flakes with either an aqueous alcohol solution or an acidic aqueous solution to remove the soluble carbohydrates from the protein and fiber. On a commercial scale, considerable expense is incurred in the handling and disposing of the resulting waste stream.

Soy protein isolates, more highly refined soy protein materials, are processed to contain at least 90% by weight on a moisture free basis of soy protein and little or no soluble carbohydrates or fiber. Soy protein isolates are typically formed by extracting soy protein and water soluble carbohydrates from defatted soy flakes or soy flour with an alkaline aqueous extractant. The aqueous extract, along with the soluble protein and soluble carbohydrates, is separated from materials that are insoluble in the extract, mainly fiber. The extract is then treated with an acid to adjust the pH of the extract to the isoelectric point of the protein to precipitate the protein from the extract. The precipitated protein is separated from the extract, which retains the soluble carbohydrates, and is dried after being adjusted to a neutral pH or is dried without any pH adjustment.

Soy protein provides gelling properties which contribute to the texture in ground and emulsified meat products. The gel structure provides dimensional stability to a cooked meat emulsion which gives the cooked meat emulsion a firm texture and gives chewiness to the cooked meat emulsion, as well as provides a matrix for retaining moisture and fats. Soy protein also acts as an emulsifier in various food applications since soy proteins are surface active and collect at oil-water interfaces, inhibiting the coalescence of fat and oil droplets. The emulsification properties of soy protein allow soy protein containing materials to be used to thicken food products such as soups and gravies. Soy protein further absorbs fat, likely as a function of its emulsification properties, and promotes fat binding in cooked foods, thereby decreasing “fatting out” of the fat in the process of cooking. Soy proteins also function to absorb water and retain it in finished food products. The moisture retention of a soy protein material may be utilized to decrease cooking loss of moisture in a meat product, providing a yield gain in the cooked weight of the meat. The retained water in the finished food products is also useful for providing a more tender mouthfeel to the product.

Naturally occurring soy proteins are generally globular proteins having a hydrophobic core surrounded by a hydrophilic shell. Numerous soy protein fractions have been identified including, for example, storage proteins such as glycinin and P-conglycinin and trypsin inhibitors such as the Bowman-Birk inhibitor and the Kunitz inhibitor. Soy protein fractions have also been characterized by their ultracentrifugation rates, in terms of their Svedberg coefficient (S). 2S, 7S (i.e., β-conglycinin), 11S (i.e., glycinin), and 15S soy proteins have been identified.

Soybean storage protein is precipitated at about pH 4.5 and can be relatively easily separated from components other than the protein. This is referred to as isolated soybean protein and, in many cases, soybean protein in this form is utilized in the food industry. Soybean protein is further divided into 2S, 7S, 11S a n d 15S globulins according to sedimentation constants in ultracentrifugation analysis. Among them, 7S globulin and 11S globulin are predominant constituent protein components of the globulin fractions (note: 7S globulin and 11S globulin are classification names in a sedimentation method and substantially correspond to β-conglycinin and glycinin according to immunological nomenclature, respectively), and both of them have specific different properties such as viscosity, coagulability, surface activity, etc. Then, fractionation of 7S globulin and 11S globulin makes it possible to utilize properties of respective protein components, and it is expected to expand industrial utilization of proteins.

7S Globulin and 11S globulin are composed of several subunits. 7S Globulin is a heterogeneous glycoprotein with a molecular weight ranging from 150 and 240 kDa. It is composed of varying combinations of three highly negatively charged subunits identified as α, (68 kDa) α′ (72 kDa), and β (52 kDa). 11S Globulin is composed of several subunits each of which is a pair of an acidic polypeptide (A) and a basic polypeptide (B). The molecular weights and charge states of 7S globulin and 11S globulin are very similar to each other. In particular, both globulins are diversified due to combinations of subunits, and properties thereof range to some extent to thereby overlap each other.

Protein fractions (e.g., 7S-rich globulin fractions or 11S-rich globulin fractions) have been precipitated from solution of a soy protein material at a pH from 4.0 to 5.0. Proteins remaining soluble in water throughout the precipitation range are commonly referred to as whey proteins.

Various processes for fractionation of protein fractions are described in the art. U.S. Pat. No. 4,368,151 to Howard et al. describes a process in which aqueous mixtures of water-soluble 7S and 11S proteins are fractionated and isolated by precipitating the 11S protein at a pH 5.8-6.3 in the presence of water-soluble salts and sulfurous ions. The pH of the enriched 7S whey may then be adjusted to a pH of 5.3-5.8 to precipitate substantially all of the remaining water-soluble 11S protein from the whey and an enriched 7S fraction may then be recovered from the whey. The fractionation is described as capable of producing either 11S-rich globulin fraction or 7S-rich globulin fraction isolates which, respectively, contain less than 5% by weight on a moisture free basis of 7S globulin or 11S globulin protein impurities.

Nagano et al. (J. Agric. Food Chem., 1992, Vol. 40, p. 941-944) describe a process in which soy proteins are extracted using water at pH 7.5, sodium bisulfilte was used as a reducing agent, and three protein fractions are precipitated at pH 6.4, 5.0, and 4.8.

Wu et al. (JAOCS, 1999, Vol. 76, No. 3, p. 285-293) describe scale-up of a laboratory process for separating 11S and 7S similar to that described by Nagano et al. (J. Agric. Food Chem., 1992, Vol. 40, p. 941-944). In the process described by Wu et al., 15 kilograms of defatted soy flakes are used and precipitation steps at pH 6.4, 5.0, and 4.8 are carried out to produce a 11S-rich globulin fraction, an intermediate fraction, and a 11S-rich globulin fraction.

Wu et al. (J. Agric. Food Chem., 2000, Vol. 48, p. 2702-2708) describe a modification of the scaled-up process in which a 11S-rich globulin fraction is precipitated at pH 6.0 and a 7S-rich globulin fraction is precipitated at pH 4.5, without precipitation of an intermediate mixture. Wu et al. reported the yield of 11S-rich globulin fraction by this method as 9.7% (dry basis, db) and the yield of 7S-rich globulin fraction as 19.6% (db). The protein content of the 7S rich globulin fraction was reported as 91.6% (db) at 62.6% purity.

7S-rich and 11S-rich globulin fractions obtained in accordance with the above processes or other processes often exhibit varying functionalities, often making them suitable for incorporation into various food products.

For example, Bian et al. (JAOCS, 2003, Vol. 80, No. 6, p. 545-549) investigated the functional properties of soy proteins fractionated by the methods of Wu et al. (JAOCS, 1999, Vol. 76, No. 3, p. 285-293) and Wu et al. (J. Agric. Food Chem., 2000, Vol. 48, p. 2702-2708). Functional properties of the three fractions produced by the method of Wu et al. (JAOCS, 1999, Vol. 76, No. 3, p. 285-293) 7S rich, 11S-rich, and intermediate globulin fractions) are studied by Bian et al. under a selected range of pH, ionic strengths, and protein concentrations. For example, the 11S-rich globulin fraction was reported to be more soluble than the 7S-rich globulin fraction at pH from 2 to 3 while the 7S rich globulin fraction was reported to be more soluble at than the 11S-rich globulin fraction at pH from 5 to 6. The 11S-rich and 7S-rich globulin fractions of the Wu et al. method (J. Agric. Food Chem., 2000, Vol. 48, p. 2702-2708) are reported to have higher solubilities at certain pHs than the fractions produced by the method of Wu et al. (JAOCS, 1999, Vol. 76, No. 3, p. 285-293).

Bringe et al. in U.S. Pat. No. 6,171,640 describe high 7S compositions having improved physical (for example, stability and gelation) and physiological (for example, cholesterol and triglyceride lowering) properties as compared to commercial soy protein ingredients. Bringe reported soy protein compositions containing greater than 40% 7S and less than 10% 11S.

Fractions precipitated between precipitation of a 11S-rich globulin fraction and a 7S-rich globulin fraction (i.e., intermediate fractions) in one or more of the processes described above (e.g., Wu et al. (JAOCS, 1999, Vol. 76, No. 3, p. 285-293)) typically contain less than 80% protein, of which less than 70% is 7S. Such intermediate fractions typically exhibit poor functionality, making them unsuitable for incorporation into food products. In addition to their undesirable functionality characteristics, the protein content of the intermediate fractions typically has an adverse effect on the yield of useful protein fraction.

Each of the processes described above suffer from one or more disadvantages, for example, undesired yield, undesired purity, or producing an undesired intermediate fraction.

Thus, a need exits for a simple and effective method for producing protein fractions and, in particular, protein fractions exhibiting improved functionalities and/or functionalities suitable for particular food applications.

### SUMMARY OF THE DISCLOSURE

Disclosed is a soy protein composition, comprising;

a mixture of 7S and 2S rich protein fraction having a O-conglycinin content greater than about 45% by weight on a moisture free basis, and having an a content of from about 15% up to about 30%, by weight on a moisture free basis, an α′ content of from about 22% up to about 40% by weight on a moisture free basis and a β content of from about 5% up to about 18% by weight on a moisture free basis;

a glycinin content of from about 13% up to about 45% by weight on a moisture free basis;

wherein a weight ratio of β-conglycinin to glycinin in the soy protein composition is from about 1 up to about 6; and

wherein a TIU/mg content in the soy protein composition is from about 50 up to about 125 before denaturation and from about 5 up to about 30 after denaturation.

Also disclosed is a process for preparing a mixture of 7S and 2S rich protein fraction having a β-conglycinin content greater than about 45% by weight on a moisture free basis, and having an a content of from about 15% up to about 30% by weight on a moisture free basis, an α′ content of from about 22% up to about 40% by weight on a moisture free basis and a β content of from about 5% up to about 18%, by weight on a moisture free basis;

a glycinin content of from about 13% up to about 45% by weight on a moisture free basis;

wherein a weight ratio of β-conglycinin to glycinin in the soy protein composition is from about 1 up to about 6; and

wherein a TIU/mg content in the soy protein composition is from about 50 up to about 125 before denaturation and from about 5 up to about 30 after denaturation, the process comprising:

in a first precipitation, precipitating a soybean 11S-rich globulin fraction from a dispersion of soy protein in a liquid medium, thereby forming a first supernatant liquid medium,

separating said soybean 11S-rich globulin fraction from said first supernatant liquid medium,

in a second precipitation, precipitating a mixture of a soybean 11S-rich globulin fraction and a soybean 7S-rich globulin fraction from said first supernatant liquid medium, thereby forming a second supernatant liquid medium, and

in a third precipitation, precipitating a mixture of 7S-rich globulin fraction and 2S-rich fraction from said second supernatant liquid.

Other objects and features of this disclosure will be in part apparent and in part pointed out hereinafter.

### DETAILED DESCRIPTION OF THE DISCLOSURE

This disclosure deals with a soy protein composition of a mixture of 7S and S rich protein fraction that has a 7S content of greater than about 45% by weight on a moisture free basis and an 11S content of from about 13% up to about 45% by weight on a moisture free basis. Further, the α 7S sub-unit is from about 15% up to about 30%, the α′ 7S sub-unit is from about 22% up to about 40%, and the β 7S sub-unit is from about 5% up to about 18%. The 7S content may be as high as about 95% by weight on a moisture free basis. This soy protein composition has a weight ratio of β-conglycinin to glycinin of from about 1 up to about 6. Further, this soy protein composition has a TIU/mg content of from about 50 up to about 125 before denaturation and from about 5 up to about 30 after denaturation.

This disclosure also deals with a process for preparing a mixture of 7S and 2S rich protein having a β-conglycinin content greater than about 45% by weight on a moisture free basis, and having an a content of from about 15% up to about 30% by weight on a moisture free basis, an ≢′ content of from about 22% up to about 40% by weight on a moisture free basis and a P content of from about 5% up to about 18% by weight on a moisture free basis;

a glycinin content of from about 13% up to about 45% by weight on a moisture free basis;

wherein a weight ratio of β-conglycinin to glycinin in the soy protein composition is from about 1 up to about 6; and

wherein a TIU/mg content in the soy protein composition is from about 50 up to about 125 before denaturation and from about 5 up to about 30 after denaturation, the process comprising:

in a first precipitation, precipitating a soybean 11S-rich globulin fraction from a dispersion of soy protein in a liquid medium, thereby forming a first supernatant liquid medium,

separating said soybean 11S-rich globulin fraction from said first supernatant liquid medium,

in a second precipitation, precipitating a mixture of a soybean 11S-rich globulin fraction and a soybean 7S-rich globulin fraction from said first supernatant liquid medium, thereby forming a second supernatant liquid medium, and

in a third precipitation, precipitating a mixture of 7S-rich globulin fraction and 2S-rich fraction from said second supernatant liquid.

The protein fractions of the present disclosure exhibit functionalities making them suitable for use as functional food ingredients in various food products. It has been observed that fractions having varying 11S, 7S, and 2S contents exhibit different functionalities including, for example, solubility and gel strength. Thus, fractions having a particular 11S, 7S, and 2S content may be preferred for particular applications

Advantageously, in certain embodiments, the process of the present disclosure is operated to include three successive precipitations, each enriched in a particular protein (e.g., 11S, a mixture of 11S and 7S, and a mixture of 7S and 2S) as described above, and suitable for incorporation into food products. Thus, the process of the present disclosure can be operated to produce different fractions suitable for incorporation into food applications while avoiding formation of an undesired intermediate fraction.

In accordance with the process of the present disclosure, protein fractions are precipitated from a soy protein-containing dispersion (i.e., feed stream) generally comprising a soy protein material suspended or otherwise dispersed in an aqueous medium (for example, water). The soy protein material is typically in the form of soy flakes, soy grits, soy meal, soy flour, soy protein concentrates, soy protein isolates, or combinations thereof. Preferably, the soy protein material is in the form of defatted soy flakes. Typically, the dispersion contains from 5% to 15% by weight soy protein material and, more typically, from 7% to 10% by weight soy protein material.

Prior to the separation of 11S, a mixture of 11S and 7S, and a mixture of 7S and 2S, a crude mixture of soy proteins and other soluble components (e.g., carbohydrates) may be prepared (e.g., extracted) from the dispersion of the starting material directly or by adjusting the pH of the aqueous dispersion. Typically, the pH of the dispersion comprising the protein material is adjusted to a pH of 7 to 10 and, more typically, to a pH of 8 to 9. The pH of the dispersion is adjusted by contacting the dispersion with an alkaline mixture. Typically, the alkaline mixture comprises a compound selected from the group consisting of sodium hydroxide, calcium hydroxide, and potassium hydroxide.

Extraction of soluble proteins and other components is typically carried out at a temperature of from 15° C. to 60° C. (from 60° F. to 140° F.) and, more typically, from 20° C. to 40° C. (70° F. to 100° F.). This extraction is typically allowed to proceed for at least 5 minutes, more typically, from 10 to 30 minutes.

Extraction of the soluble proteins and other components results in a extract comprising 11S, 7S, and 2S, and other soluble components (e.g., soluble carbohydrates), and an insoluble fraction comprising spent material (e.g., soy fiber) from which protein has been removed.

The insoluble fraction is typically separated from the extract by centrifuging using, for example, a Sharples 3400 decanting centrifuge manufactured by Alfa Laval Separation Inc. (Warminster, Pa.). The insoluble fraction may also be separated from the extract by filtration.

A reducing agent can be added to the separated extract (i.e., extract) in order to facilitate separation of 11S, a mixture of 11S and 7S, and a mixture of 7S and 2S by reduction of the disulfide bonds of the proteins. It is currently believed reduction of the disulfide bonds facilitates this separation by untangling the proteins of 11S, a mixture of 11S and 7S, and a mixture of 7S and 2S. 11S typically contains a greater proportion of disulfide bonds; thus, reducing agent is preferably added prior to adjustment of the extract pH for precipitation of the 11S-rich globulin fraction. Suitable reducing agents include sodium bisulfite, dithiothreitol, and mercaptoethanol. Preferably, the reducing agent comprises sodium bisulfite since sodium bisulfite satisfies the relevant food-grade regulations.

Typically, at least 0.1 g reducing agent per L extract are introduced thereto, more typically from 0.1 to 1.0 g reducing agent per L extract and, still more typically, from 0.2 to 0.6 g reducing agent per L extract. Introduction of such amounts of reducing agents typically results in suitable reducing agent content in the soy protein fractions produced by the present disclosure for incorporation into food products (e.g., less than 100 parts per million (ppm)). When used, the reducing agent is added in such an amount that the concentration of reducing agent in the soy fraction is less than 100 ppm, in another embodiment less than 20 ppm, and, still in another embodiment, less than 10 ppm.

In accordance with the present process, the pH of the extract, regardless of introduction of a reducing agent thereto, is adjusted to precipitate a 11S-rich globulin fraction. The pH of the extract is typically adjusted by introducing an acidic mixture comprising a compound selected from the group consisting of hydrochloric acid, phosphoric acid, and sulfuric acid. Preferably, the pH of the extract is adjusted by introduction of an acidic mixture comprising hydrochloric acid.

It has been observed that 11S precipitation is favored as the pH of the extract decreases, thereby increasing the purity of the 11S-rich globulin fraction. Typically, the pH of the extract is adjusted to between 5.8 and 6.8.

In accordance with the process of the present disclosure, it has been discovered that addition of a divalent metal ion to the extract enhances separation of the protein fractions.

In certain embodiments, addition of a divalent metal ion to the extract prior to precipitation of a 11S-rich globulin fraction provides a 11S-rich globulin fraction having more uniform particle size and, further advantageously, increased average particle size of precipitated protein as compared to precipitates produced in the absence of a divalent metal ion. Typically, addition of a divalent metal ion results in an 11S-rich globulin fraction having a particle size distribution, in terms of particle diameter, of from 1 μm to 52 μm. More typically, the particle size distribution is from 2 μm to 16 μm. The average particle size of precipitated protein of a 11S-rich globulin fraction precipitated in the presence of a divalent metal ion, in terms of particle diameter, is typically at least 5 μm and, more typically, at least 6 μm. Achieving greater uniformity of particle size distribution and increased overall particle size aids in separation of the 11S-rich globulin fraction.

Suitable sources of the divalent metal ion include salts of alkaline earth metals, for example, calcium and magnesium. In a preferred embodiment, the source of a divalent metal ion comprises CaCl, and in another, MgCl₂.

Typically, the source of divalent metal ion is present in the extract at a concentration of at least 0.01 molar. Additionally or alternatively, the source of a divalent metal ion is present in the extract at a concentration of at least 0.5% by weight. Further, additionally or alternatively, at least 0.001 g source of divalent metal ion per liter extract are introduced thereto.

Adjusting the pH of the extract produces an insoluble 11S-rich globulin fraction and a soluble fraction comprising some remaining 11S, 7S, and 2S. The precipitation of the 11S-rich globulin fraction is typically carried out at a temperature of from 15° C. to 35° C. (from 60° F. to 95° F.) and, more typically, from 20° C. to 32° C. (70° F. to 90° F.). During precipitation of the soluble proteins, typically the extract is agitated. Typically, the extract is agitated by stirring. The means and intensity of agitation are not critical but typically are selected so that the extract is agitated to a degree sufficient to promote uniform pH and transfer of proteins from the aqueous to solid phase.

The first supernatant produced by precipitation of an 11S-rich globulin fraction typically comprises at least 3.5% by weight protein, more typically at least 5% by weight protein and, still more typically, from 5% to 7% by weight on a moisture free basis of protein.

The pH of the first supernatant is adjusted to precipitate a mixture of 11S and 7S-rich globulin fraction typically by introducing an acidic mixture comprising a compound selected from the group consisting of hydrochloric acid, phosphoric acid, and sulfuric acid to the supernatant. Preferably, the pH of the supernatant is adjusted by addition of hydrochloric acid.

Typically, the pH of the supernatant is adjusted from the 11S precipitation pH to from 4.8 to 5.8. Precipitation of the mixture of 11S and 7S-rich globulin fraction forms a second supernatant mixture.

The pH of the second supernatant is adjusted to precipitate a mixture of 7S-rich globulin fraction and 2S-rich globulin fraction from said second supernatant liquid. This procedure is carried out typically introducing an acidic mixture comprising a compound selected from the group consisting of hydrochloric acid, phosphoric acid, and sulfuric acid to the second supernatant. Preferably, the pH of the second supernatant is adjusted by addition of hydrochloric acid. Typically, the pH of the second supernatant is adjusted to between about 4.0 to about 4.8.

The precipitated 11S-rich, mixture of 11S- and 7S-rich fractions, and mixture of 7S- and 2S-rich globulin fraction are typically separated from the respective soluble fraction by centrifugation using, for example, a Sharples 3400 decanting centrifuge manufactured by Alfa Laval Separation Inc. (Warminister, Pa.). The precipitated fractions may also be separated by filtration.

Typically, at least 40% by weight on a moisture free basis of the soy protein present in the 11 s-rich globulin fraction has a molecular weight of less than 800,000 daltons.

Typically, at least 40% by weight on a moisture free basis of said soy protein in said mixture of 11S rich globulin fraction and 7S-rich globulin fraction has a molecular weight of from 200,000 to 400,000 daltons.

Typically, at least 40% by weight on a moisture free basis of said soy protein in said mixture of 7S-rich globulin fraction and 2S-rich fraction has a molecular weight of from 1350 to 100,000 daltons.

Typically, most of the soluble carbohydrates remain in the supernatant produced during precipitation of the 11S-rich globulin fraction, mixture of 11S- and 7S-rich globulin fraction, and mixture of 7S- and 2S-rich globulin fraction.

The third precipitation containing the mixture of 7S- and 2S-rich fraction and bioactive polypeptides have a high TIU/mg content. The mixture of 7S-rich globulin fraction and 2S-rich globulin fraction obtained in the third precipitation has a trypsin inhibitor activity of from about 25 up to about 100 TIU/gram before denaturation. The TI U/mg is denatured by heat treatment to be from about 5 up to about 30.

As used herein, the term “trypsin inhibitor activity” refers to the activity of soy material components in inhibiting trypsin activity as measured trypsin inhibition units (TIU). Trypsin inhibitor activity of a soy material may be measured according to A.O.C.S. Official Method Ba 12-75 (1997), incorporated herein in its entirety by reference. According to the method, 1 gram of soy material is mixed with 50 milliliters of 0.01N aqueous sodium hydroxide solution for a period of 3 hours to extract the trypsin inhibiting components from the soy material. An aliquot of the extract suspension is diluted until the absorbance of a 1 milliliter aliquot assay at 410 nm is between 0.4 and 0.6 times the absorbance of a 0 milliliter assay (blank). 0, 0.6, 1.0, 1.4, and 1.8 milliliter aliquots of the diluted suspension are added to duplicate sets of test tubes, and sufficient water is added to bring the volume in each test tube to 20 milliliters. Two milliliters of trypsin solution is mixed in each tube and incubated for several minutes to allow the trypsin inhibiting factors to react with the added trypsin. A 5 milliliter aliquot of benzoyl-D, L-arginine-p-nitroanilide (BAPNA) solution, commercially available from Sigma Chemical Company, St. Louis, Mo., is then added to each tube. Uninhibited trypsin catalyzes the hydrolysis of BAPNA, forming yellow-colored p-nitroaniline. A blank is also prepared of 2 milliliters of the dilute suspension and 5 milliliters of BAPNA. After exactly ten minutes of reaction, the hydrolysis of the diluted suspensions and the blank is halted by adding 1 milliliter of acetic acid. 2 milliliters of trypsin solution is then added to the blank and mixed therein. The contents of each tube and the blank are filtered through filter paper, and are centrifuged for 5 minutes at 10,000 rpm. The yellow supernatant solutions are measured spectrophotometrically for absorbance at 410 nm. Trypsin inhibitor activity is evaluated from the difference in degree of BAPNA hydrolysis between the blank and the samples, where one TIU is defined as an increase equal to 0.01 absorbance units at 410 nm after 10 minutes of reaction per 10 milliliters of final reaction volume. Trypsin inhibitor units per milliliters of diluted sample suspension may be calculated according to the formula: TIU/ml=100×[(absorbance of the blank)−(absorbance of the sample solution)]/(number of milliliters of diluted sample suspension used in the assay).

In addition to protein content, yield and purity of the fraction can be important considerations, for example, as indicators of the effectiveness of the fractionation and likely functionalities of the fractions. Generally, it has been observed that as the yield of a particular protein in a fraction rich in that protein increases, the purity of the fraction decreases. Thus, the present process is preferably operated such that protein yields provide a commercially feasible process while producing fractions of purities sufficient to provide functionalities which make them suitable for use in various food applications.

Soy concentrate, as the term is used herein, refers to a soy protein material containing about 65% to about 790% of soy protein on a moisture free basis (mfb). Soy protein isolate, as the term is used herein, refers to a soy protein material containing at least about 90% or greater protein content, and preferably from about 92% or greater protein content (mfb).

As a generic example of the present disclosure, soybeans are initially crushed or ground and then passed through a conventional oil expeller. It is preferable, however, to remove the oil contained in the soybeans by solvent extraction with aliphatic hydrocarbons, such as hexane or azeotropes thereof, and these represent conventional techniques employed for the removal of oil. The defatted soy protein material or soybean flakes are then placed in an aqueous bath to provide a mixture having a pH of at least about 6.5 and preferably between about 7.0 and 10.0 in order to extract the protein. Typically, if it is desired to elevate the pH above 7.0, various alkaline reagents such as sodium hydroxide, potassium hydroxide and calcium hydroxide or other commonly accepted food grade alkaline reagents may be employed to elevate the pH. A pH of above about 7.0 is generally preferred, since an alkaline extraction facilitates solubilization of the protein. Typically, the pH of the aqueous extract of protein will be at least about 6.5 and preferably about 7.0 to 10.0. The ratio by weight of the aqueous extractant to the soy protein material is usually between about 20 to 1 and preferably a ratio of about 10 to 1. In an alternative embodiment, the soy protein is extracted from the milled, defatted flakes with water, that is, without a pH adjustment.

In addition to alkaline reagent, metal chlorides and sulfites (or sulfides or sulfates) may be employed to aid protein separation. Metal chloride and metal sulfite (or sulfides or sulfates) solutes may be added to the batch to create a batch concentration range from 0.001 M to 1 M. These solutes may be added prior to extraction or prior to precipitation or not at all.

It is also desirable in obtaining the soy protein extract used in the present disclosure, that an elevated temperature be employed during the aqueous extraction step, either with or without a pH adjustment, to facilitate solubilization of the protein, although ambient temperatures are equally satisfactory if desired. The extraction temperatures which may be employed can range from ambient up to about 120° F. with a preferred temperature of 90° F. The period of extraction is further non-limiting and a period of time between about 5 to 120 minutes may be conveniently employed with a preferred time of about 30 minutes. Following extraction of the soy protein material, the aqueous extract of protein can be stored in a holding tank or suitable container while a second extraction is performed on the insoluble solids from the first aqueous extraction step. The two extracts are then combined. This improves the efficiency and yield of the extraction process by exhaustively extracting the protein from the residual solids from the first step.

The combined, aqueous protein extracts from both extraction steps, with a pH of between 7.0 to 10, are then partially precipitated by adjustment of the pH of the extracts to, at or near the isoelectric point of the 11S protein to form an insoluble curd precipitate and a soluble protein containing whey. The actual pH to which the protein extracts are adjusted will vary depending upon the soy protein material employed but insofar as 11S soy protein, this typically is between about 5.8 and 6.8. The precipitation step may be conveniently carried out by the addition of a common food grade acidic reagent such as acetic acid, sulfuric acid, phosphoric acid, hydrochloric acid or with any other suitable acidic reagent. The soy protein that precipitates from the acidified extract, is then separated as a supernatant. The supernatant (protein containing whey) is pH adjusted to between 4.8 and 5.8 to precipitate a 7S/11S mixture of soy protein. The soy protein that precipitates is then separated from the supernatant. This step may be repeated if desired. The supernatant (protein containing whey) is pH adjusted to between 4.0 and 4.8 to precipitate a mixture of 7S-rich globulin fraction and 2S-rich fraction from said second supernatant enriched mixture of soy protein. The soy protein that precipitates is then separated from the supernatant. The separated protein from any of these steps may be washed with water to remove residual soluble carbohydrates and ash from the protein material. A successful separation can be monitored in the process by the high elasticity of the final precipitated protein (similar to bread dough). Additional metal chloride or metal sulfite (or sulfides or sulfates) may be added prior to any of these precipitation steps. The separated protein of the third precipitation is then dried using conventional drying means to form a soy protein isolate. The resultant mixture of 7S-rich globulin fraction and 2S-rich fraction from said second supernatant liquid will have 60 to 100% by weight on a moisture free basis of the contained soy proteins as measures by SDS-Page electrophoresis. In addition, this material will have a trypsin inhibitor value of from about 25 up to about 100 TIU/mg) before denaturing. These protease inhibitors may be partially denatured by dissolving the material in water, with or without metal sulfites (or sulfides or sulfates) and refluxing for 30 to 60 minutes at atmospheric pressure followed by drying. This step may be required for material efficacy to improve cardiovascular health in animals, including humans.

The 7S and 11S analysis herein are determined upon the basis of their sodium dodecyl sulfate (SDS) polyacrylamide gel electrophoresis profiles. Quantitation of the individual species is obtained by densitometric scanning of the SDS gel profiles. The total 7S globulin fraction is a sum of the alpha′, alpha and beta subunits as described by Thanh et al. (Biochem. Biophys. Acta., 490 (1977) 370-384). The total 11S soy globulin fraction is likewise the sum of the acidic and basic subunits as described by Catsimpoolas et al. (Jr. Sci. Food Agric., 22 (1971) 448-450). The 7S and 11S soy proteins are isolated by the procedure of Thanh et al. (Jr. Agric. Food Chem. 24 (1976) 1117-1121) and are used as standards for SDS polyacrylamide gel electrophoresis.

The SDS polyacrylamide gel electrophoresis is performed as described by Laemmli, Nature (London) 227 (1970) 680-685) with a vertical slab cell (Bio-Rad Laboratories, Richmond, Calif., Model 220) and D.C. power supply (LKB, Bromma, Sweden, 2103). The separating and stacking gels are 10.5% and 4.5% acrylamide, respectively. Soy protein samples and standards are solubilized in 0.0625 M Tris-HCl buffer, pH 6.8 containing 1.0% w/v SDS, 10% w/v glycerol, 2% w/v 2-Mercaptoethanol and heated for 5 minutes at 100° C. The gels (2) are run for 1.5 hr. at 30 mA followed by 1.5-2 hr. at 80 mA. Molecular weight calibration protein standards are obtained from Pharmacea Fine Chemicals (Piscataway, N.J., LMW kit).

The proteins are stained (Wang, K., Biochem. 16 (1977) 1857-1865) in 0.1% w/v Coomassee Blue R-250 in 2-propanol-acetic acid-water, 25-10-65, V/V/V. Destaining is performed in a slab diffusion destained (Bio-Rad Laboratories, Richmond Calif., Model 222) in 2-propanol-acetic acid-water, 10-10-80, V/V/V. The destained gels are scanned using a densitometer (E-C Apparatus Corp., Model EC-910) and dual channel, integrating OmniScribe® recorder (Houston Instruments, Austin, Tex., Model 5000).

The percent distribution of the soy proteins is calculated by sum of the areas of the individual subunit species representing the 7S or 11S soy protein aggregates divided by the total area of scan times 100 as determined by the following equations I and II:
% 7S protein=α′+α+and β/Total area of Scan×100 I
% 11S protein=A Sub.+B Sub./Total area of Scan×100 II
wherein α′, α and β represent the major subunit species area of the 7S globulin as defined by Thanh et al.; and the A Sub. and B Sub. respectively represent the acidic and basic subunit areas of the 11S globulin as defined by Catsimpoolas et al.

Preferably the soy protein composition of the present disclosure is modified to enhance the characteristics of the protein material. The modifications are modifications which are known in the art to improve the utility or characteristics of a protein material and include, but are not limited to, denaturation and hydrolysis of the protein material.

The soy protein composition may be denatured and hydrolyzed to lower the viscosity. Chemical denaturation and hydrolysis of protein materials is well known in the art and typically consists of treating a protein material with one or more alkaline reagents in an aqueous solution under controlled conditions of pH and temperature for a period of time sufficient to denature and hydrolyze the protein material to a desired extent. Typical conditions utilized for chemical denaturing and hydrolyzing a protein material are: a pH of up to about 10, preferably up to about 9.7; a temperature of about 50° C. to about 80° C. and a time period of about 15 minutes to about 3 hours, where the denaturation and hydrolysis of the protein material occurs more rapidly at higher pH and temperature conditions.

Hydrolysis of the soy protein composition may also be effected by treating the soy protein composition with an enzyme capable of hydrolyzing the protein. Many enzymes are known in the alt which hydrolyze protein materials, including, but not limited to, fungal proteases, pectinases, lactases, and chymotrypsin. Enzyme hydrolysis is effected by adding a sufficient amount of enzyme to an aqueous dispersion of protein material, typically from about 0.1% to about 10% enzyme by weight of the protein material, and treating the enzyme and protein dispersion at a temperature, typically from about 5° C. to about 75° C., and a pH, typically from about 3 to about 9, at which the enzyme is active for a period of tine sufficient to hydrolyze the protein material. After sufficient hydrolysis has occurred the enzyme is deactivated by heating, and the protein material is precipitated from the solution by adjusting the pH of the solution to about the isoelectric point of the protein material. Enzymes having utility for hydrolysis in the present disclosure include, but are not limited to, bromelain and alcalase.

The mixture of 7S and 2S rich protein globulin fractions of the present disclosure are then typically further processed to aid in incorporation of the globulin fractions into food products. Such further processing includes, for example, heat treatment to destroy microorganisms present in the globulin fractions (e.g., pasteurization and/or sterilization) and drying (e.g., spray drying). Typically, pasteurization includes heating the globulin fraction to a temperature of at least 95° C. (at least 203° F.), more typically at least 130° C. (265° F.) and, more typically, to a temperature of from 130° C. to 150° C. (from 265° F. to 305° F.).

The mixture of 7S and 2S rich protein globulin fractions may also be spray dried to produce a free-flowing powder typically having a moisture content of less than 504 by weight and, more typically, less than 10% by weight. The mixture of 7S and 2S rich protein globulin fractions are typically spray dried at temperatures of at least 95° C. (200° F.).

The soy protein composition of the mixture of 7S and 2S rich protein fraction has a 7S content of greater than about 45%, preferably greater than 50% and most preferably greater than 55% by weight on a moisture free basis. The soy protein composition of the mixture of 7S and 2S rich protein fraction has an 11S content of from about 13% up to about 45% and preferably up to about 40% by weight on a moisture free basis. The α 7S sub-unit is from about 15% up to about 30%, preferably up to about 28%, and most preferably up to about 26% by weight on a moisture free basis. The α′ 7S sub-unit is from about 22% up to about 40% and preferably between about 24% and about 38% by weight on a moisture free basis. The β 7S sub-unit is from about 5% up to about 18%, preferably between about 6% and about 14%, and most preferably between about 7% and about 13% by weight on a moisture free basis.

The present disclosure is illustrated by the following examples which are merely for the purpose of illustration and not to be regarded as limiting the scope of the disclosure or manner in which it may be practiced.

In order for the TIU/mg to be from about 5 up to about 30, the mixture of a 7S protein globulin fraction and 2S protein globulin fraction, needs to go through a denaturation step. Denaturation is a heat treatment step. In instances where the dry soy protein composition has a TIU/mg above 50, the dried composition is reslurried in water to between about 8% and about 13%, solids, sparged to 160° F., held for one hour, pasteurized and then spray dried. This procedure requires two spray dry steps. One spray dry step to obtain the mixture of a 7S protein globulin fraction and 2S protein globulin fraction having a TIU/mg from about 50 up to about 125 and the other spray dry step following denaturation which lowers the TIU/mg from between about 5 and about 30. Alternatively, rather than spray dry twice, after the third precipitate is obtained and neutralized, water is added to form a slurry and the slurry is sent to a vacuumizer for 30 minutes at 180° F. Pasteurization, homogenization and a single spray drying are carried out as per Example 1.

### EXAMPLE 1

Added to an extraction tank are 1000 pounds water at 90° F. and 500 pounds soy flakes to form a first extract slurry. Sufficient sodium hydroxide is added to adjust the pH to 9.7. The soy flakes are extracted for a period of 30 minutes after which a first aqueous extract solution is separated from the first extract slurry by centrifugation and the first extract solution is transferred to a holding tank. The extracted flakes residue are redispersed in 3000 pounds of water and stirred for 30 minutes to form a second extract slurry. A second aqueous extract solution is separated from this extract slurry by centrifugation and the second extract solution is added to the first extract solution to form a combined extract solution. Sodium bisulfite is added to this combined extract solution to create a batch concentration of 0.5 millimolar (mM). The pH of the extract solution is lowered to 6.2 by the addition of 37% hydrochloric acid to form a first slurry. Within the first slurry is a first precipitate of an 11S protein globulin fraction, which is separated out to leave behind a first supernatant. Sodium chloride is added to the first supernatant to create a batch concentration of 0.02 M. The pH of this supernatant is lowered to 5.0 by the addition of 37% hydrochloric acid to form a second slurry. Within the second slurry is a second precipitate of a mixture of an 11S protein globulin fraction and 7S protein globulin fraction, which is separated out to leave behind a second supernatant. The pH of the second supernatant is lowered to 4.3 by the addition of 37% hydrochloric acid to form a third slurry. Within the third slurry is a third precipitate of a mixture of a 75 protein globulin fraction and 2S protein globulin fraction, which is separated out to give solids and a third supernatant. The third supernatant is discarded. The solids of the third precipitate are reslurried with water and sodium hydroxide is added to raise the pH up to about 7.0. These contents are pasteurized at 305° F., homogenized at 500 pounds per square inch and spray dried to give a dry, neutral mixture of a 7S protein globulin fraction and 2S protein globulin fraction, having a TIU/mg of 102 before denaturing. After denaturing the mixture of a 7S protein globulin fraction and 2S protein globulin fraction, has a TIU/mg of 17.5.

### EXAMPLE 2

The procedure of Example 1 is repeated except that the sodium bisulfite is added to create a batch concentration of 4.3 (mM). The composition of this Example has a TIU/mg of 59.2 before denaturing. After denaturing the mixture of a 7S protein globulin fraction and 2S protein globulin fraction, has a TIU/mg of 27.3.

### EXAMPLE 3

The procedure of Example 2 is repeated except that the third precipitate is reslurried in water, the slurry sent to a vacuumizer, followed by pasteurization, homogenization and spray drying. The composition of this Example has a TIU/mg of 9.3 after denaturing.

### EXAMPLE 4

The procedure of Example 3 is repeated. The composition of this Example has a TIU/mg of 8.1 after denaturing.

### EXAMPLE 5

The procedure of Example 3 is repeated. The composition of this Example has a TIU/mg of 7.5 after denaturing.

### EXAMPLE 6

Added to an extraction tank are 1000 pounds water at 90° F. and 500 pounds soy flakes to form a first extract slurry. Sufficient sodium hydroxide is added to adjust the pH to 9.7. The soy flakes are extracted for a period of 30 minutes after which a first aqueous extract solution is separated from the first extract slurry by centrifugation and the first extract solution is transferred to a holding tank. The extracted flakes residue are redispersed in 3000 pounds per hour of water and stirred for 30 minutes to form a second extract slurry. A second aqueous extract solution is separated from this extract slurry by centrifugation and the second extract solution is added to the first extract solution to form a combined extract solution. Sodium bisulfite is added to this combined extract solution to create a batch concentration of 10 (mM). A first slurry is formed by adjusting the pH of the extract solution is to 6.2 by the addition of 37% hydrochloric acid and held for one hour. Additional hydrochloric acid is added to lower the pH to 5.3. Within the first slurry is a first precipitate of an 11S protein globulin fraction, which is separated out to leave behind a first supernatant. Sodium chloride is added to the first supernatant to create a batch concentration of 0.02 M. The pH of this supernatant is lowered to 5.0 by the addition of 37% hydrochloric acid to form a second slurry. Within the second slurry is a second precipitate of a mixture of an 11S protein globulin fraction and 7S protein globulin fraction, which is separated out to leave behind a second supernatant. The pH of the second supernatant is lowered to 4.5 by the addition of 37% hydrochloric acid to form a third slurry. Within the third slurry is a third precipitate of a mixture of a 7S protein globulin fraction and 2S protein globulin fraction, which is separated out to give solids and a third supernatant. The third supernatant is discarded. The solids of the third precipitate are reslurried with water and sodium hydroxide is added to raise the pH up to about 7.0. These contents are pasteurized at 305° F., homogenized at 500 pounds per square inch and spray dried to give a dry, neutral mixture of a 7S protein globulin fraction and 2S protein globulin fraction.

The below Table I delineates the analyses of the above Examples.

TABLE 1

| | 7S | | | | 11S | | Totals | | TIU/mg | TIU/mg |
|---|---|---|---|---|---|---|---|---|---|---|
| Example | α | α′ | β | acidic | basic | 7S | 11S | 7S/11S | before denat | after denat |
| 1 | 21.49 | 36.55 | 7.83 | 1.61 | 28.36 | 65.87 | 29.97 | 2.2 | 102.0 | 17.5 |
| 2 | 15.87 | 24.78 | 7.6 | 8.22 | 32.97 | 48.25 | 41.19 | 1.2 | 59.2 | 27.3 |
| 3 | 25.59 | 32.19 | 12.08 | 6.38 | 17.78 | 69.86 | 24.16 | 2.9 | — | 9.3 |
| 4 | 19.33 | 30.85 | 12.68 | 5.03 | 26.54 | 62.86 | 31.57 | 2.0 | — | 8.1 |
| 5 | | | | | | | | | — | 7.5 |
| 6 | 24.33 | 36.46 | 16.96 | 4.97 | 9.99 | 77.75 | 14.96 | 5.2 | | |

The soy protein composition of the mixture of 7S and 2S rich protein fraction exhibit varying functionalities due to their varying protein contents. These globulin fractions are suitable for use as functional food ingredients in a variety of food and beverage applications including, for example, meat products such as hot dogs and sausages, beverages such as soy milk and fruit juices, yogurts, and food bars. Generally, 7S-rich protein globulin fractions are preferred for use in meat applications and certain beverage applications (e.g., soy milk).

The protein globulin fractions of the present disclosure are capable of forming a gel in an aqueous solution due, at least in part, to the aggregation of the partially denatured proteins of the fractions. Substantial gel formation in an aqueous environment is a desirable quality of the fractions of the present disclosure since their gelling properties contribute to the texture and structure of meat products in which they are used. This quality of the globulin fractions also provides a matrix for retaining moisture and fats in the meat products to enable a cooked meat product containing the unrefined soy protein material to retain its juices during cooking.

The protein globulin fractions of the present disclosure are also capable of forming gels that have significant gel strength. Gel strength is a measure of the strength of a gel prepared by mixing a sample of soy material and water for a period of time sufficient to permit the formation of a gel. Gels having a 1:5 soy material:water ratio, by weight (including the moisture content of the soy material in the water weight) are prepared and used to fill a 3 piece 307×113 millimeter aluminum can which is sealed with a lid.

The gel strength may be determined generally for gels at room temperature (i.e., from 15° C. to 25° C.) and may also be measured for refrigerated gels (i.e., cold gel strength), pasteurized gels (i.e., pasteurized gel strength), and retorted gels (i.e., retorted gel strength). These various measurements relate to the suitability of the soy protein material in various applications.

To determine gel strength, a can containing the gel is opened and the gel is separated from the can. The strength of the gel is measured with an instrument which drives a probe into the gel until the gel breaks and measures the break point of the gel (preferably an Instroni Universal Testing Instrument Model No. 1122 with 36 mm disk probe); and calculating the gel strength from the recorded break point of the gel. Gel strength may be measured for gels with and without salt, gels containing salt typically contain 2% by weight salt. Salt is generally used in the gel strength measurements when suitability of the soy protein material in food applications containing salt is of interest.

Gel strength is calculated according to the following formula:
Gel Strength (grams)=(F/100)(G)(454);
where F is the point of gel fracture, in chart units; 100 is the possible number of chart units; G is the full scale load dial reading times 10 (in pounds) of the instrument; and 454 is the number of grams per pound.

As an indicator of suitability for incorporation into food products containing salt, gel strength is also measured for a gel containing a protein fraction, water, and salt (for example, sodium chloride).

Cold gel strength is a measure of the strength of a gel of a soy material following refrigeration immediately after preparation at −5° C. to 5° C. for a period of time (usually from 16 to 24 hours) sufficient for the gel to equilibrate to the refrigeration temperature. Thus, cold gel strength may provide an indication of suitability of the soy protein material for use in a product which will be refrigerated.

For pasteurized gel strength, cans containing the gel are placed in contact with boiling water for approximately 30 minutes, cooled with approximately 30° C. water, and then refrigerated at −5° C. to 5° C. for a period of time (usually from 16 to 24 hours) sufficient for the gel to equilibrate to the refrigeration temperature. Pasteurized gel strength generally may indicate the effect of heat treatment on the soy protein material.

For some food applications the ability of a soy protein material to form an emulsion and various features of such emulsions are important functional characteristics. Oil and water are not miscible and, in the absence of a material to stabilize the interface between them, the total surface area of the interface will be minimized. This typically leads to separate oil and water phrases. Proteins can stabilize these interfaces by denaturing onto the surface providing a coating to a droplet (oil or water). The protein can interact with both the oil and the water and, in effect, insulate them from each other. Large molecular weight proteins are believed to be more able to denature onto such a droplet surface and provide greater stability than small proteins and thereby prevent droplet coalescence.

The texture, strength, and stability, of emulsions prepared using a protein fraction of the present disclosure may also be determined as an indicator of the suitability of the protein for use in applications containing water and oil components (e.g., various meat applications such as hot dogs).

An emulsion of a soy protein material to be evaluated is prepared by adding soybean oil (840 g 0.1 g) which has been equilibrated at (20±3)° C. to a beaker having a capacity of 1000 ml. The soybean oil is then introduced into the chopper bowl of a Hobart Food Cutter, Model # 84145, manufactured by the Hobart Corporation (Troy, OH) with the oil remaining in the beaker minimized by thoroughly scraping the surface of the beaker with a rubber spatula. The temperature of the food cutter bowl and lid is generally (20±3)° C.; this may be accomplished by rinsing the bowl and lid in cool tap water (e.g., at a temperature of from n15° C. to 25° C.) after cleaning and before emulsion preparation. Soy material sample (200.0 g 0.1 g) is introduced to the cutter bowl, quickly spreading the material over the entire surface of the oil. After the soy material sample is introduced to the oil, the food cutter lid is closed, the food cutter is started and timing begins. The time taken to add the soy material sample to the oil and start the food cutter is typically less than 15 seconds. Water (1,150 10 ml) at (20±3)° C. is measured in a 2 liter graduated cylinder. The water is introduced to the food cutter within 10 seconds after starting the food cutter. After one minute of chopping time has elapsed, the food cutter and timer are stopped. The lid of the food cutter is removed and thoroughly scraped with a rubber spatula. The lid is closed, the timer started, and chopping continues for four minutes. If desired, at five minutes total chopping time, salt (44.0±0.1)g is added during one revolution of the bowl. Salt may be included in the emulsion characteristics for purposes of determining suitability of the soy protein materials in food applications containing salt (e.g., meat applications). At 5.5 minutes total chopping time, the food cutter and timer are stopped and the inside of the lid is thoroughly scraped. Chopping is resumed for an additional 1.5 minutes. At the end of seven minutes total chop time, the food cutter is stopped and a sample of the emulsion is obtained from the emulsion ring in the bowl (i.e., the sample is not taken from the side of the bowl or the lid of the cutter). The total elapsed time for emulsion preparation typically does not exceed 10 minutes.

A container which has a capacity of approximately 175 ml (6.0 ounces) is filled with the emulsion, taking care to pack it with no air pockets. The container has a height of 3.8 cm and diameter of 8 cm. The top of the cup is scraped with a stainless steel spatula leaving a smooth, even surface and the cup is allowed to stand undisturbed at room temperature for 5 minutes. The sample of emulsion in the cup is analyzed for its emulsion texture using a TA.TXT2 Texture Analyzer manufactured by Stable Micro Systems Ltd. (England). The gel tester speed control is set on the “fast” setting and the 21.5 mm probe is attached to the gel tester. The emulsion-containing cup is placed on the gel tester balance and positioned so that the probe will penetrate the surface of the emulsion approximately in the center of the cup, avoiding any irregularities in the surface. The balance is then tared and 5 minutes after the cup was filled, the “down” button on the gel tester is pressed to begin analysis. The display on the balance as the probe penetrates the emulsion is observed. The emulsion texture or, hardness, is the maximum force in grams observed on the balance before the probe automatically returns to the ready position.

Typically, an emulsion consisting of a protein fraction suitable for use in meat applications, oil, and water at a weight ratio of protein fraction to water of from 1:4 to 1:6 and a weight ratio of protein fraction to oil of from 1:4 to 1:5 exhibits an emulsion texture of at least 90 grams and, more typically, at least 110 grams.

Three to four containers (e.g., an aluminum can having a capacity of 177 ml (6 oz) or a 205 ml (7 oz) plastic cup manufactured by Solo) are prepared as described above for measuring emulsion texture. The containers are inverted and placed onto a flat tray made from non-absorbing material and covered with plastic film.

The samples in aluminum cans are kept in boiling water for approximately 30 minutes, chilled in an ice water bath for approximately 15 minutes, and refrigerated at (5±2)° C. for from 20 hours to 32 hours. Measurements obtained from these samples represent the “hot” emulsion strength of the sample.

Plastic containers are refrigerated at (5±2)° C. for from 16 hours to 32 hours. Measurements obtained from these samples represent the “cold” emulsion strength of the sample.

The sample of emulsion in the cup is analyzed for its emulsion strength using a TA.TXT2 Texture Analyzer manufactured by Stable Micro Systems Ltd. (England). The gel tester speed control is set to the “slow” setting and the 10.9 mm probe is attached to the gel tester. A container is removed from the refrigerator in such a way that the surface of the emulsion is not disturbed. If the surface of the emulsion is irregular, uneven, or damaged, the container is discarded and another container is removed for analysis. The container is placed on the gel tester balance and positioned such that the probe will penetrate the surface of the emulsion approximately in the center of the cup. The balance is tared and the “down” button on the gel tester is pressed to begin analysis. The balance on the display is observed as the probe penetrates the emulsion. The reading will increase to a maximum after which time the reading will remain constant or drop abruptly. The maximum reading is recorded, in grams, as the emulsion strength. The sample in a second container is analyzed as described. If the difference between the two readings is less than ten grams, the average of the two values is reported. If the difference between the two readings is ten grams or more, the samples in the remaining containers are analyzed and the average of the readings is reported.

Emulsion texture and strength both generally relate to the hardness or, firmness, of the emulsion. Such characteristics generally indicate the suitability of the protein fractions for incorporation into products (for example, meat applications) in which a firm product is desired.

An emulsion consisting of a protein fraction suitable for use in meat applications, oil, and water at a weight ratio of protein fraction to water of from 1:4 to 1:6 and a weight ratio of protein fraction to oil of from 1:4 to 1:5, generally exhibits an emulsion strength of at least 90 grams and, more typically, at least 110 grams.

To determine emulsion stability, three containers are prepared as described above for measuring emulsion texture (i.e., containing either hot or cold samples). The balance is tared to zero using a clean sheet of weighing paper. Two emulsion filled cups are removed from the refrigerator. The emulsion is carefully removed from each cup and cut in half longitudinally. Each half is placed on a sheet of weighing paper. If the sample weighs less than 85 grams, the sample is discarded and another is obtained. If the sample weighs from 85 g to 90 g the weight is recorded. If the sample weighs greater than 90 g, emulsion is removed from the uppermost curved side of the emulsion half to provide a sample weighing from 85 to 90 grams. The initial weight of the sample is recorded. Four halves of the emulsion sample from the refrigerated containers are evaluated. A cooking surface of a commercially available skillet (e.g., having a diameter of 12″ and depth of 2″) is prepared by lightly spraying with cooking spray and preheated at 70° C. for approximately 15 minutes. The emulsion halves are placed on the preheated skillet one at a time at 30 second intervals. The samples are fried at approximately 170° C. for 10 minutes. Each sample is weighed as it is removed from the skillet and its final weight is recorded. The skillet is cleaned before evaluating the next emulsion.

The emulsion stability is calculated as the percent weight loss of sample during cooking:
Emulsion Stability=(Initial Weight−Final Weight)/Initial Weight)×100%

Emulsion stability, as an indicator of moisture loss upon cooking (as the value increases, stability decreases), may be an important indicator of the suitability of the soy protein material for use in meat applications (e.g., hot dogs) in which moisture retention during cooking affects the mouthfeel of the product.

Emulsion capacity may be an important characteristic of a protein fraction to be incorporated into a food product containing water and oil components present as an emulsion. The protein fraction provides the interface of the oil and water of an emulsion. If the protein fraction does not have suitable emulsion capacity the components of the emulsion may separate; for example, in the case of a meat application in which the oil is not retained within the cohesive mass the product will not exhibit sufficient firmness or structure. The emulsion capacity of a soy protein material may be determined by preparing a 2% by weight solids dispersion of a soy protein material in water. Soybean oil is then added to the dispersion (25 g) at a rate of 10 ml/min to form an oil in water emulsion. Eventually, addition of the soybean oil will produce a water in oil emulsion (i.e., an emulsion inversion point is reached). The volume of oil added up to the emulsion inversion point is recorded and the emulsion capacity is calculated as the maximum amount of oil that could be emulsified by 1 gram of protein.

Aqueous dispersions consisting of 2% by weight of a protein fraction suitable for use in meat application, at a pH of 7, typically has an emulsion capacity of at least 400 grains oil/gram protein and, more typically, at least 600 grams oil/gram protein.

One important functionality characteristic of the proteins of the fractions of the present disclosure is their solubility in an aqueous solution, often expressed in terms of the nitrogen solubility index of the fraction. Fractions containing highly aqueous-soluble soy protein have a nitrogen solubility index of greater than 80%, while fractions containing large quantities of aqueous-insoluble soy protein have a nitrogen solubility index less than 25%.

Nitrogen Solubility Index (NSI) as used herein is defined as:
NSI=(% water soluble nitrogen of a protein containing sample/% total nitrogen in protein containing sample)×100.

The nitrogen solubility index provides a measure of the percent of water soluble protein relative to total protein in a protein containing material. The nitrogen solubility index of a fraction of the present disclosure is measured in accordance with standard analytical methods, specifically A.O.C.S. Method Ba 11-65, which is incorporated herein by reference in its entirety. According to the Method Ba 11-65, a soy material sample (5 grams) ground fine enough so that at least 95% of the sample will pass through a U.S. grade 100 mesh screen (average particle size of less than 150 microns) is suspended in distilled water (200 ml), with stirring at 120 rpm, at 30° C. for two hours; the sample is then diluted to 250 milliliters with additional distilled water. If the soy material is a full-fat material the sample need only be ground fine enough so that at least 80% of the material will pass through a U.S. grade 80 mesh screen (approximately 175 μm), and 90% will pass through a U.S. grade 60 mesh screen (approximately 205 μm). Dry ice is typically added to the soy material sample during grinding to prevent denaturation of sample. Sample extract (40 ml) is decanted and centrifuged for 10 minutes at 1500 rpm, and an aliquot of the supernatant is analyzed for Kjeldahl protein (PRKR) to determine the percent of water soluble nitrogen in the soy material sample according to A.O.C.S Official Methods Bc 4-91 (1997), Ba 4d-90, or Aa 5-91, hereby incorporated by reference in their entirety. A separate portion of the soy material sample is analyzed for total protein by the PRKR method to determine the total nitrogen in the sample. The resulting values of Percent Water Soluble Nitrogen and Percent Total Nitrogen are utilized in the formula above to calculate the nitrogen solubility index. Depending on the intended application of the soy protein material, the solubility of the soy protein materials at various pH values may also be of interest. The percent of soluble protein is determined as described above except the sample extract (40 ml) is decanted and centrifuged for 10 minutes at 1000 rpm. The solubility of the soy protein material may be determined for a wide pH range, for example, over a range of from 2 to 10.

The solubility of the protein fractions affects whether the fractions are preferred for incorporation in certain food products. For example, highly soluble fractions are preferred for use in beverage applications to avoid formation of a precipitate which is generally undesired by consumers. Thus, in the case of beverage applications, preferably the soy protein fraction has a nitrogen solubility index of at least 65% and, more preferably, from 75% to 90%.

The protein fractions of the present disclosure retain their solubility in aqueous media containing salt (for example, sodium chloride). This is an important feature of the protein fractions of the present disclosure since they may be used as functional food ingredients in food products containing significant amounts of salt (e.g., emulsified meats or soups). Such solubilities are typically expressed in terms of the salt tolerance index which may be determined using the following method. Sodium chloride (0.75 grams) is weighed and added to a 400 ml beaker. Water (150 ml) at (30±1)° C. is added to the beaker, and the salt is dissolved completely in the water. The salt solution is added to a mixing chamber, and a sample of a soy material (5 grams) is added to the salt solution in the mixing chamber. The sample and salt solution are blended for 5 minutes at 7000 revolutions per minute (rpm) ±200 rpm. The resulting slurry is transferred to a 400 milliliter beaker, and water (50 ml) is used to rinse the mixing chamber. The 50 ml rinse is added to the slurry and the beaker containing the slurry is placed in 30° C. water bath and is stirred at 120 rpm for a period of 60 minutes. The contents of the beaker are then quantitatively transferred to a 250 ml volumetric flask using deionized water. The slurry is diluted to 250 milliliters with deionized water, and the contents of the flask are mixed thoroughly by inverting the flask several times. A sample of the slurry (45 ml) is transferred to a 50 milliliter centrifuge tube and the slurry is centrifuged for 10 minutes at 500 times the gravitational constant. The supernatant is filtered from the centrifuge tube through filter paper into a 100 milliliter beaker. Protein content analysis is then performed on the filtrate and on the original dry soy material sample according to A.O.C.S Official Methods Bc 4-91 (1997), Ba 4d-90, or Aa 5-91, hereby incorporated by reference in their entirety.

The salt tolerance index (STI) is calculated according to the following formula:
STI(%)=(100)(50)(P_{f}/P_{d})
wherein P_{f} represents the Percent Soluble Protein in the filtrate while P_{d} represents the Percent Total Protein in the dry soy material sample.

To use the soy protein composition of the present disclosure in a food application, the soy protein composition is combined and blended with at least one food ingredient. The food ingredient(s) is/are selected based upon the desired food product. Food ingredients that may be used with the soy protein material composition of the present disclosure include: emulsified meats; soup stock for producing soups; dairy ingredients, including cultured dairy products; and bread ingredients.

A particularly preferred application in which the soy protein material composition of the present disclosure is used is in emulsified meats. The soy protein composition may be used in emulsified meats to provide structure to the emulsified meat, which gives the emulsified meat a firm bite and a meaty texture. The soy protein composition also decreases cooking loss of moisture from the emulsified meat by readily absorbing water, and prevents “fatting out” of the fat in the meat so the cooked meat is juicier.

The meat material used to form a meat emulsion in combination with the soy protein composition of the present disclosure is preferably a meat useful for forming sausages, frankfurters, or other meat products which are formed by filling a casing with a meat material, or can be a meat which is useful in ground meat applications such as hamburgers, meat loaf and minced meat products. Particularly preferred meat materials used in combination with the soy protein material composition include mechanically deboned meat from chicken, beef, and pork; pork trimmings; beef trimmings; and pork backfat.

A meat emulsion containing a meat material and the soy protein composition contains quantities of each which are selected to provide the meat emulsion with desirable meat-like characteristics, especially a firm texture and a firm bite. Preferably the soy protein composition is present in the meat emulsion in an amount of from about 1% to about 30%, by weight, more preferably from about 3% to about 20%, by weight. Preferably the meat material is present in the meat emulsion in an amount of from about 35% to about 70%, by weight, more preferably from about 40% to about 60%, by weight. The meat emulsion also contains water, which is preferably present in an amount of from about 25% to about 55%, by weight, and more preferably from about 30% to about 40%, by weight.

The meat emulsion may also contain other ingredients that provide preservative, flavoring, or coloration qualities to the meat emulsion. For example, the meat emulsion may contain salt, preferably from about 1% to about 4% by weight; spices, preferably from about 0.01% to about 3% by weight; and preservatives such as nitrates, preferably from about 0.01 to about 0.5% by weight.

While the disclosure has been explained in relation to its preferred embodiments, it is to be understood that various modifications thereof will become apparent to those skilled in the art upon reading the description. Therefore, it is to be understood that the disclosure disclosed herein is intended to cover such modifications as fall within the scope of the appended claims.

What is claimed is:

1. A soy protein composition, comprising;
a mixture of 7S and 2S rich protein fraction having a β-conglycinin content greater than about 45% by weight on a moisture free basis, and having an α content of from about 15% up to about 30% by weight on a moisture free basis, an α′ content of from about 22% up to about 40% by weight on a moisture free basis and a β content of from about 5% up to about 18% by weight on a moisture free basis;
a glycinin content of from about 13% up to about 45% by weight on a moisture free basis;
wherein a weight ratio of β-conglycinin to glycinin in the soy protein composition is from about 1 up to about 6; and
wherein a TIU/mg content in the soy protein composition is from about 50 up to about 125 before denaturation and from about 5 up to about 30 after denaturation.

2. The soy protein composition of claim 1 wherein the β-conglycinin content is greater than about 50% by weight on a moisture free basis.

3. The soy protein composition of claim 1 wherein the glycinin content is up to about 40% by weight on a moisture free basis.

4. The soy protein composition of claim 1 wherein the a content is up to about 28% by weight on a moisture free basis, the α′ content is from about 24% up to about 38% by weight on a moisture free basis and the β content is from about 6% up to about 14% by weight on a moisture free basis.

5. A process for preparing a mixture of 7S and 2S rich soy protein fraction having a β-conglycinin content greater than about 45% by weight on a moisture free basis, and having an a content of from about 15% up to about 30% by weight on a moisture free basis, an α′ content of from about 22% up to about 40% by weight on a moisture free basis and a β content of from about 5% up to about 18% by weight on a moisture free basis;
a glycinin content of from about 13% up to about 45% by weight on a moisture free basis;
wherein a weight ratio of β-conglycinin to glycinin in the soy protein composition is from about 1 up to about 6; and
wherein a TIU/mg content in the soy protein composition is from about 50 up to about 125 before denaturation and from about 5 up to about 30 after denaturation, the process comprising:
adding an acid to a dispersion of soy protein in a liquid medium to form a first precipitate of a soy 11S-rich globulin fraction and a first supernatant liquid medium;
separating said soy 11S-rich globulin fraction precipitate from said first supernatant liquid medium;
adding an acid to said first supernatant liquid medium to form a second precipitate of a mixture of soy 11S and 7S rich globulin fraction and a second supernatant liquid medium;
separating said soy 11S and 7S rich globulin fraction precipitate from said second supernatant liquid medium;
adding an acid to said second supernatant liquid medium to form a third precipitate of a mixture of soy 7S and 2S rich globulin fraction and a third supernatant liquid medium; and
separating said mixture of 7S and 2S rich globulin fraction precipitate from said third supernatant liquid medium.

6. The process as set forth in claim 5 wherein said dispersion of soy protein in a liquid medium comprises soy flakes, soy grits, soy meal, soy flour, soy protein concentrates, soy protein isolates, or combinations thereof.

7. The process as set forth in claim 5 wherein said dispersion of soy protein in a liquid medium contains an alkali metal hydroxide selected from the group consisting of sodium hydroxide, calcium hydroxide, and potassium hydroxide.

8. The process as set forth in claim 5 wherein the dispersion of soy protein in the liquid medium has a pH of from 7.0 to 10.0.

9. The process as set forth in claim 5 wherein the pH of the dispersion of soy protein is adjusted to a pH of from 5.8 to 6.8 for precipitating said 11S-rich globulin fraction.

10. The process as set forth in claim 5 wherein the pH of said first supernatant liquid medium is adjusted to a pH of from 4.8 to 5.8 for precipitating said mixture of 11S-rich globulin fraction and 7S-rich globulin fraction.

11. The process as set forth in claim 5 wherein the pH of said second supernatant liquid medium is adjusted to a pH of from 4.0 to 4.8 for precipitating a mixture of 7S-rich globulin fraction and 2S-rich globulin fraction.

12. The process as set forth in claim 5 wherein at least 40% by weight of said soy protein in said 11S-rich globulin fraction has a molecular weight of less than 800,000 daltons.

13. The process as set forth in claim 5 wherein at least 40% by weight on a moisture free basis of said soy protein in said mixture of 11S rich globulin fraction and 7S-rich globulin fraction has a molecular weight of from 200,000 to 400,000 daltons.

14. The process as set forth in claim 5 wherein at least 40% by weight on a moisture free basis of said soy protein in said mixture of 7S-rich globulin fraction and 2S-rich fraction has a molecular weight of from 1350 to 100,000 daltons.

15. A food product comprising a blend of
a mixture of 7S and 2S rich protein fraction having a β-conglycinin content greater than about 45% by weight on a moisture free basis, and having a β-conglycinin content greater than about 45% by weight on a moisture free basis, and having an a content of from about 15% up to about 30%, by weight on a moisture free basis, an α′ content of from about 22% up to about 40% by weight on a moisture free basis and a β content of from about 5% up to about 18% by weight on a moisture free basis;
a glycinin content of from about 13% up to about 45% by weight on a moisture flee basis;
wherein a weight ratio of β-conglycinin to glycinin in the soy protein composition is from about 1 up to about 6; and
wherein a TIU/mg content in the soy protein composition is from about 50 up to about 125 before denaturation and from about 5 up to about 30 after denaturation; and
at least one food ingredient.

16. The food product of claim 15, wherein the food ingredient is an emulsified meat.

17. The food product of claim 15, wherein the food ingredient is soup stock.

18. The food product of claim 15, wherein the food ingredient is a dairy product.

19. The food product of claim 15, wherein the food ingredient is a bread ingredient.
